(19) United States
(12) Patent Application Publication
(10) Pub. No.: US 2016/0249381 A1
(43) Pub. Date: Aug. 25, 2016

(54) METHOD OF TRANSMITTING DATA AND DEVICE USING THE SAME

(71) Applicant: LG ELECTRONICS INC., Seoul (KR)

(72) Inventors: Jinsoo CHOI, Seoul (KR); Jinyoung CHUN, Seoul (KR); Wookbong LEE, Seoul (KR); Dongguk LIM, Seoul (KR); Hangyu CHO, Seoul (KR)

(73) Assignee: LG ELECTRONICS INC., Seoul (KR)

(21) Appl. No.: 15/030,361

(22) PCT Filed: Oct. 20, 2014
(86) PCT No.: PCT/KR2014/009833

§ 371 Date: Apr. 18, 2016

Related U.S. Application Data
(60) Provisional application No. 61/896,666, filed on Oct. 29, 2013.
(60) Provisional application No. 62/012,410, filed on Jun. 15, 2014.

(51) Int. Cl. H04W 74/00; H04W 72/12; H04W 74/06

(52) U.S. Cl. CPC H04W 74/004; H04W 74/06; H04W 74/006; H04W 72/121; H04W 84/12

(57) ABSTRACT

A method and device for transmitting data in a wireless local area network are provided. An access point receives a plurality of transmission opportunity (TXOP) requests for requesting a TXOP configuration from a plurality of transmission stations. The access point transmits a TXOP polling regarding the TXOP configuration to the plurality of transmission stations. The access point receives a plurality of data blocks from the plurality of transmission stations during the configured TXOP.

### BACKGROUND OF THE INVENTION

1. Field of the invention

The present invention relates to a wireless communication and, more particularly, to a method of transmitting data in a wireless local area network and a device using the same.

2. Related Art

The Wi-Fi is a Wireless Local Area Network (WLAN) technology that enables a device to be connected to the Internet in a frequency band of 2.4 GHz, 5 GHz or 60 GHz. A WLAN is based on Institute of Electrical and Electronics Engineers (IEEE) 802.11 standard.

The IEEE 802.11n standard supports multiple antennas and provides a maximum data rate of 600 Mbits/s. A system that supports the IEEE 802.11n standard is called a High Throughput (HT) system.

The IEEE 802.11ac standard mostly operates in a 5 GHz band and provides a data rate of 1 Gbit/s or more. IEEE 802.11ac supports downlink Multi-User Multiple Input Multiple Output (MU-MIMO). A system that supports IEEE 802.11ac is called a Very High Throughput (VHT) system.

A IEEE 802.11ax is being developed as a next-generation WLAN for handling a higher data rate and a higher user load. The scope of IEEE 802.11ax may include 1) the improvements of the 802.11 physical (PHY) layer and the Medium Access Control (MAC) layer, 2) the improvements of spectrum efficiency and area throughput, 3) performance improvement in an environment under an interference source, a crowded heterogeneous network environment, and an environment having heavy user load.

The conventional IEEE 802.11 standard supports only Orthogonal Frequency Division Multiplexing (OFDM). In contrast, in a next-generation WLAN, supporting Orthogonal Frequency Division Multiple Access (OFDMA) capable of multi-user access is being taken into consideration.

There is a need for a scheme for support OFDMA in a WLAN.

### SUMMARY OF THE INVENTION

The present invention provides a method of transmitting data and a device using the same.

In an aspect, a method for transmitting data in a wireless local area network is provided. The method includes receiving, by an access point (AP), a plurality of transmission opportunity (TXOP) requests for requesting a TXOP configuration from a plurality of transmission stations, transmitting, by the AP, a TXOP polling regarding the TXOP configuration to the plurality of transmission stations, and receiving, by the AP, a plurality of data blocks from the plurality of transmission stations during the configured TXOP.

The plurality of data blocks may include a plurality of physical layer protocol data units (PPDUs).

In another aspect, a device for a wireless local area network includes a radio frequency (RF) unit configured to transmit and receive radio signals, and a processor connected to the RF unit and configured to instruct the RF unit to receive a plurality of transmission opportunity (TXOP) requests for requesting a TXOP configuration from a plurality of transmission stations, instruct the RF unit to transmit a TXOP polling regarding the TXOP configuration to the plurality of transmission stations, and instruct the RF unit to receive a plurality of data blocks from the plurality of transmission stations during the configured TXOP.

There is provided an operation for supporting Orthogonal Frequency Division Multiple Access (OFDMA) in a wireless local area network.

### BRIEF DESCRIPTION OF THE DRAWINGS

FIG. 1 illustrates a conventional PPDU format;

FIG. 2 illustrates an example of a proposed PPDU format for a WLAN;

FIG. 3 illustrates another example of a proposed PPDU format for a WLAN;

FIG. 4 illustrates yet another example of a proposed PPDU format for a WLAN;

FIG. 5 illustrates an example of phase rotation for the classification of PPDUs;

FIG. 6 illustrates the operation of channels according to IEEE 802.11ac standard;

FIG. 7 illustrates limitations according to a conventional channel operation;

FIG. 8 illustrates an example of the operation of channels using OFDMA;

FIG. 9 illustrates an example of a TXOP configuration;

FIG. 10 illustrates an example of a proposed PPDU format; and

FIG. 11 is a block diagram illustrating a wireless device in which an embodiment of the present invention is implemented.

### DESCRIPTION OF EXEMPLARY EMBODIMENTS

For clarity, a Wireless Local Area Network (WLAN) system in accordance with the Institute of Electrical and Electronics Engineers (IEEE) 802.11n standard is called a High Throughput (HT) system, and a system in accordance with the IEEE 802.11ac standard is called a Very High Throughput (VHT) system. A WLAN system in accordance with proposed methods is called a High Efficiency WLAN (HEW) system or a High Efficiency (HE) system. The term “HEW” or “HE” is used to distinguish it from a conventional WLAN, and any restriction is not imposed on the term.

A proposed WLAN system may operate in a frequency band of 6 GHz or less or a frequency band of 60 GHz. The frequency band of 6 GHz or less may include at least one of a 2.4 GHz band and a 5 GHz band.

A station (STA) may be called various names, such as a wireless device, a Mobile Station (MS), a network interface device, and a wireless interface device. An STA may include a non-AP STA or an Access Point (AP) unless the function of the STA is separately distinguished from that of an AP. When it is said that communication is performed between an STA and an AP, the STA may be construed as being a non-AP STA. When it is said that communication is performed between an STA and an AP or the function of an AP is not separately required, an STA may be a non-AP STA or an AP.

A Physical layer Protocol Data Unit (PPDU) is a data block that is generated in the physical (PHY) layer in IEEE 802.11 standard.

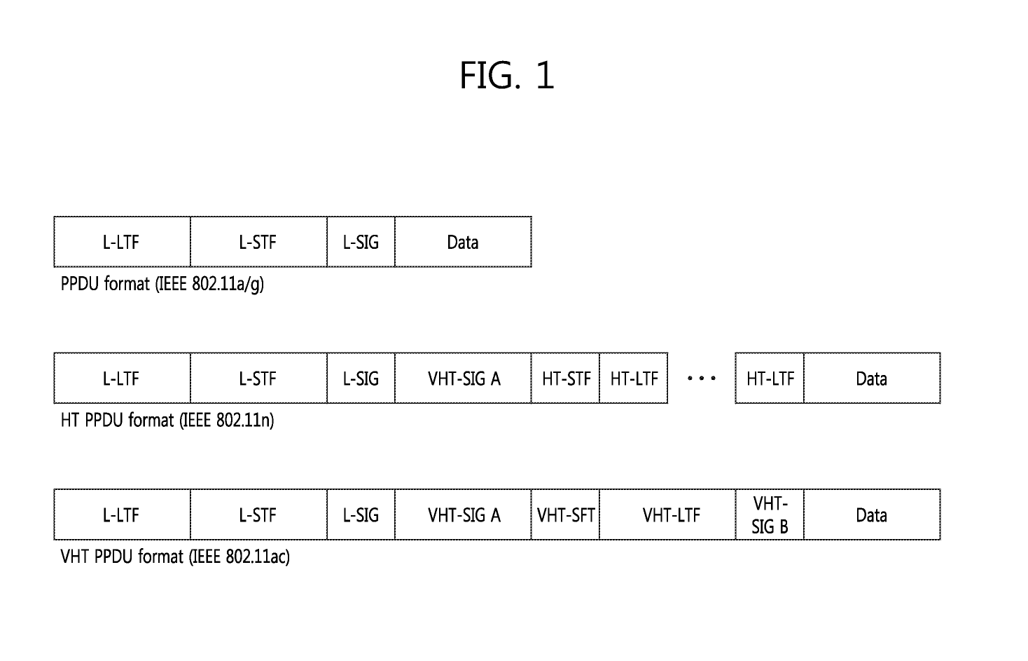

FIG. 1 illustrates a conventional PPDU format.

A PPDU supporting IEEE 802.11a/g includes a Legacy-Short Training Field (L-STF), a Legacy-Long Training Field (L-LTF), and a legacy-signal (L-SIG). The L-STF may be used for frame detection, Automatic Gain Control (AGC), etc. The L-LTF may be used for fine frequency/time synchronization and channel estimation.

An HT PPDU supporting IEEE 802.11n includes a VHT-SIG, an HT-STF, and HT-LTFs which are sequentially subsequent to an L-SIG.

A VHT PPDU supporting IEEE 802.11ac includes a VHT-SIG A, a VHT-STF, a VHT-LTF, and a VHT-SIG B which are sequentially subsequent to an L-SIG.

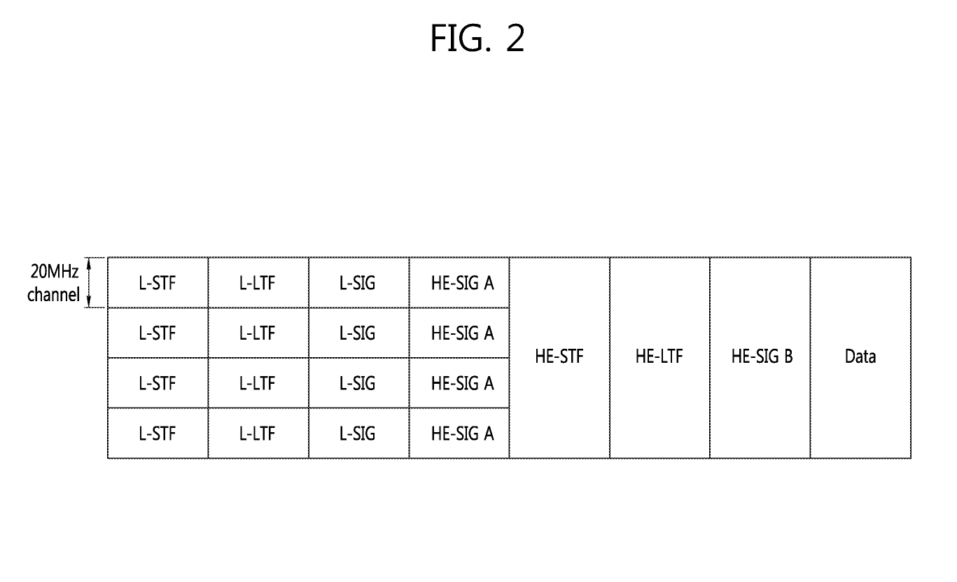

FIG. 2 illustrates an example of a proposed PPDU format for a WLAN.

FIG. 2 illustrates the PPDU that is transmitted in a total of an 80-MHz bandwidth through four 20 MHz channels. The PPDU may be transmitted through at least one 20 MHz channel FIG. 2 illustrates an example in which an 80-MHz band has been allocated to a single reception STA. The four 20 MHz channels may be allocated to different reception STAs.

An L-STF, an L-LTF, and an L-SIG may be the same as the L-STF, L-LTF, and L-SIG of a VHT PPDU. The L-STF, the L-LTF, and the L-SIG may be transmitted in an Orthogonal Frequency Division Multiplexing (OFDM) symbol generated based on 64 Fast Fourier Transform (FFT) points (or 64 subcarriers) in each 20 MHz channel.

An HE-SIG A may include common control information that is in common received by STAs receiving a PPDU. The HE-SIG A may be transmitted in two or three OFDM symbols.

The following table illustrates information included in the HE-SIG A. The names of fields or the number of bits is only illustrative, and all the fields are not essential.

TABLE 1

| FIELD | BIT | DESCRIPTION |
|---|---|---|
| Bandwidth | 2 | Indicating a bandwidth in which a PPDU is |
| | | transmitted. For example, 20 MHz, 40 MHz, |
| | | 80 MHz or 160 MHz |
| Group ID | 6 | Indicating an STA or a group of STAs that |
| | | will receive a PPDU |
| Stream information | 12 | Indicating the number or location of spatial |
| | | streams for each STA, or the number or |
| | | location of spatial streams for a group of |
| | | STAs |
| Uplink (UL) | 1 | Indicating whether a PPDU is destined to an |
| indication | | AP (uplink) or to an STA (downlink) |
| MU indication | 1 | Indicating whether a PPDU is an SU-MIMO |
| | | PPDU or an MU-MIMO PPDU |
| Guard Interval (GI) | 1 | Indicating whether a short GI or a long GI is |
| indication | | used |
| Allocation | 12 | Indicating a band or a channel (subchannel |
| information | | index or subband index) allocated to each |
| | | STA in a bandwidth in which a PPDU is |
| | | transmitted |
| Transmission power | 12 | Indicating a transmission power for each |
| | | channel or each STA |

The HE-STF may be used to improve AGC estimation in MIMO transmission. The HE-LTF may be used to estimate an MIMO channel.

The HE-SIG B may include user-specific information that is required for each STA to receive its own data (i.e., a Physical Layer Service Data Unit (PSDU)). The HE-SIG B may be transmitted in one or two OFDM symbols. For example, the HE-SIG B may include information about the length of a corresponding PSDU and the Modulation and Coding Scheme (MCS) of the corresponding PSDU.

The L-STF, the L-LTF, the L-SIG, and the HE-SIG A may be duplicately transmitted in a unit of 20 MHz channel For example, when a PPDU is transmitted through four 20 MHz channels, the L-STF, the L-LTF, L-STG and the HE-SIG A are duplicately transmitted every 20 MHz channel

An FFT size per unit frequency may be further increased from the HE-STF (or from the HE-SIG A). For example, 256 FFT may be used in a 20 MHz channel, 512 FFT may be used in a 40 MHz channel, and 1024 FFT may be used in an 80 MHz channel If the FFT size is increased, the number of OFDM subcarriers per unit frequency is increased because spacing between OFDM subcarriers is reduced, but an OFDM symbol time may be increased. In order to improve efficiency, the length of a GI after the HE-STF may be configured to be the same as that of the GI of the HE-SIG A.

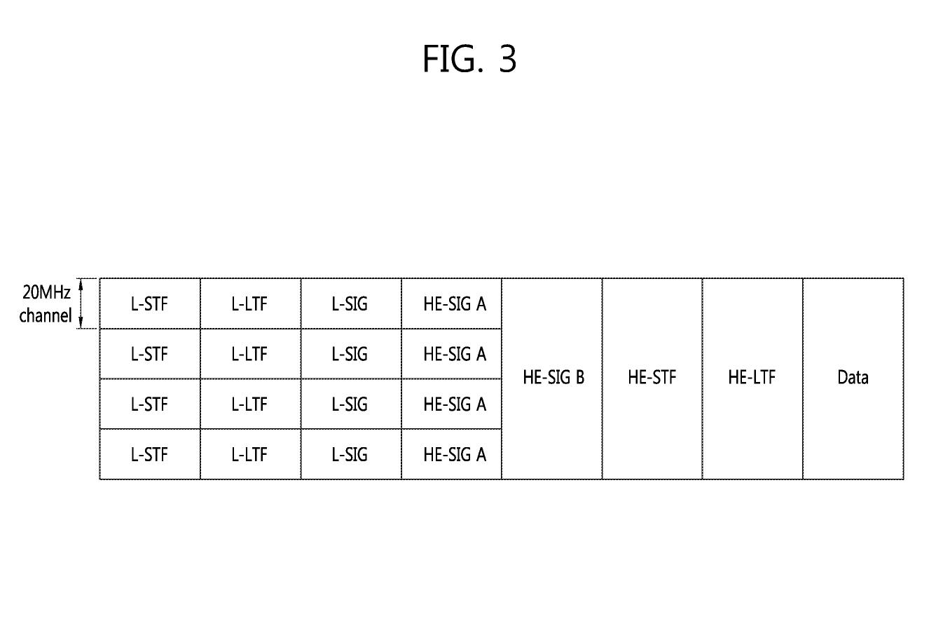

FIG. 3 illustrates another example of a proposed PPDU format for a WLAN.

The PPDU formation is the same as that of FIG. 2 except that the HE-SIG B is placed behind the HE-SIG A. An FFT size per unit frequency may be further increased after the HE-STF (or the HE-SIG B).

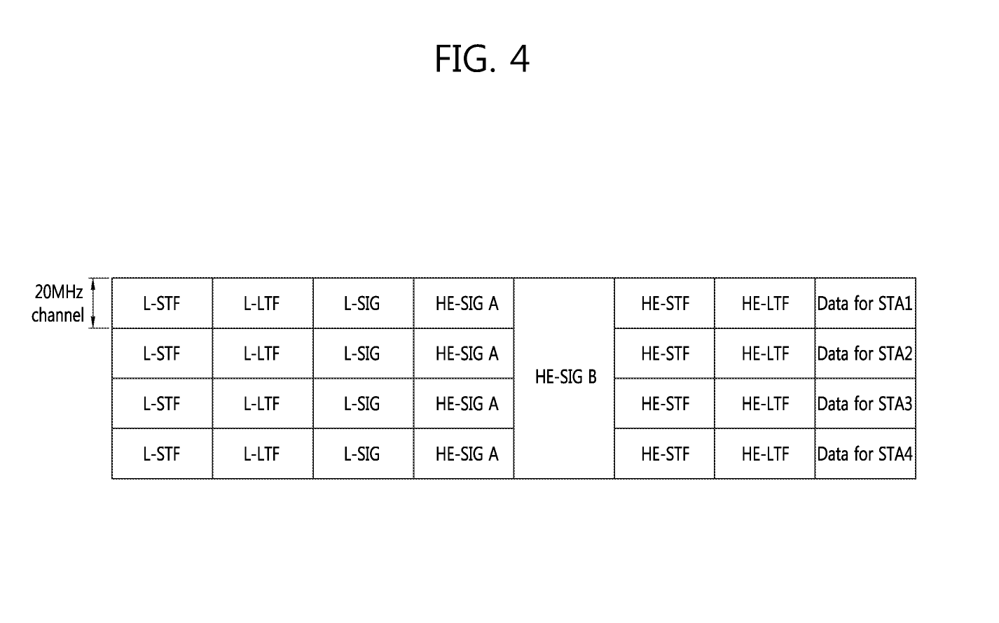

FIG. 4 illustrates yet another example of a proposed PPDU format for a WLAN.

An HE-SIG B is placed behind an HE-SIG A. 20 MHz channels are allocated to different STAs (e.g., an STA1, an STA2, an STA3, and an STA4). The HE-SIG B includes information specific to each STA, but is encoded over the entire band. That is, the HE-SIG B may be received by all the STAs. An FFT size per unit frequency may be further increased after the HE-STF (or the HE-SIG B).

If the FFT size is increased, a legacy STA supports conventional IEEE 802.11a/g/n/ac is unable to decode a corresponding PPDU. For coexistence between a legacy STA and an HE STA, an L-STF, an L-LTF, and an L-SIG are transmitted through 64 FFT in a 20 MHz channel so that they can be received by a conventional STA. For example, the L-SIG may occupy a single OFDM symbol, a single OFDM symbol time may be 4 us, and a GI may be 0.8 us.

The HE-SIG A includes information that is required for an HE STA to decode an HE PPDU, but may be transmitted through 64 FFT in a 20 MHz channel so that it may be received by both a legacy STA and an HE STA. The reason for this is that an HE STA is capable of receiving conventional HT/VHT PPDUs in addition to an HE PPDU. In this case, it is required that a legacy STA and an HE STA distinguish an HE PPDU from an HT/VHT PPDU, and vice versa.

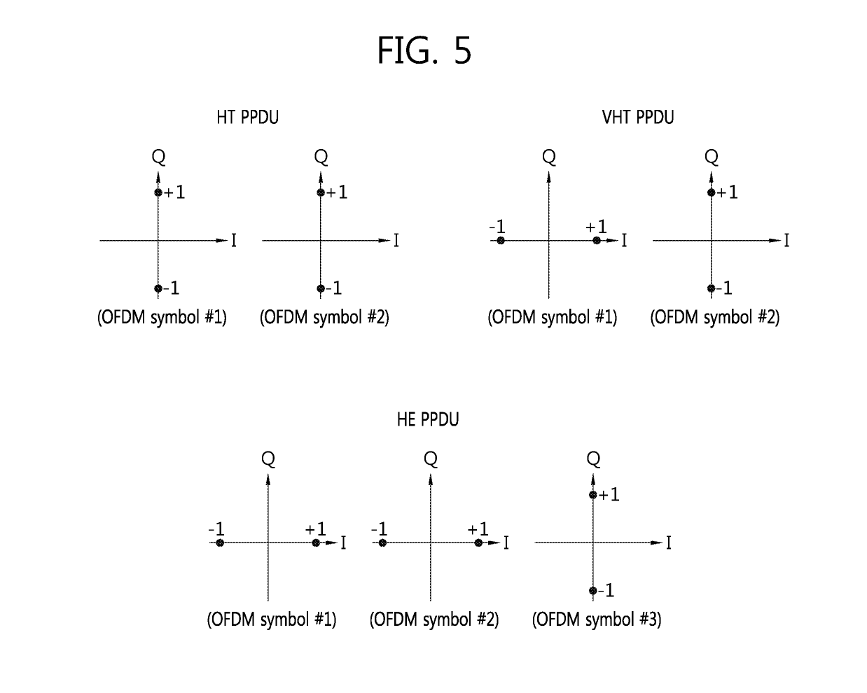

FIG. 5 illustrates an example of phase rotation for the classification of PPDUs.

For the classification of PPDUs, the phase of the constellation of OFDM symbols transmitted after an L-STF, an L-LTF, and an L-SIG is used.

An OFDM symbol#1 is a first OFDM symbol after an L-SIG, an OFDM symbol#2 is an OFDM symbol subsequent to the OFDM symbol#1, and an OFDM symbol#3 is an OFDM symbol subsequent to the OFDM symbol#2.

In a non-HT PPDU, the phases of constellations used in the first OFDM symbol and the second OFDM symbol are the same. Binary Phase Shift Keying (BPSK) is used in both the first OFDM symbol and the second OFDM symbol.

In an HT PPDU, the phases of constellations used in the OFDM symbol#1 and the OFDM symbol#2 are the same and are counterclockwise rotated by 90 degrees. A modulation scheme having a constellation rotated by 90 degrees is called Quadrature Binary Phase Shift Keying (QBPSK).

In a VHT PPDU, the phase of a constellation used in the OFDM symbol#1 is not rotated, but the phase of a constellation used in the OFDM symbol#2 is counterclockwise rotated by 90 degrees like in the HT PPDU. The OFDM symbol#1 and the OFDM symbol#2 are used to send a VHT-SIG A because the VHT-SIG A is transmitted after the L-SIG and transmitted in the second OFDM symbol.

For the classification of HT/VHT PPDUs, the phases of three OFDM symbols transmitted after the L-SIG may be used in an HE-PPDU. The phases of the OFDM symbol#1 and the OFDM symbol#2 are not rotated, but the phase of the OFDM symbol#3 is counterclockwise rotated by 90 degrees. BPSK modulation is used in the OFDM symbol#1 and the OFDM symbol #2, and QBPSK modulation is used in the OFDM symbol#3.

If the HE-SIG A is transmitted in three OFDM symbols after the L-SIG, it may be said that all the OFDM symbols #1/#2/#3 are used to send the HE-SIG A.

In a conventional WLAN system, the operation of multiple channels is used to provide a wider bandwidth in a single STA. Furthermore, whether or not to use a secondary channel is determined depending on a Clear Channel Assessment (CCA) result of a primary channel The reason for this is that the secondary channel is assumed to be used in an Overlapped Basic Service Set (OBSS) environment.

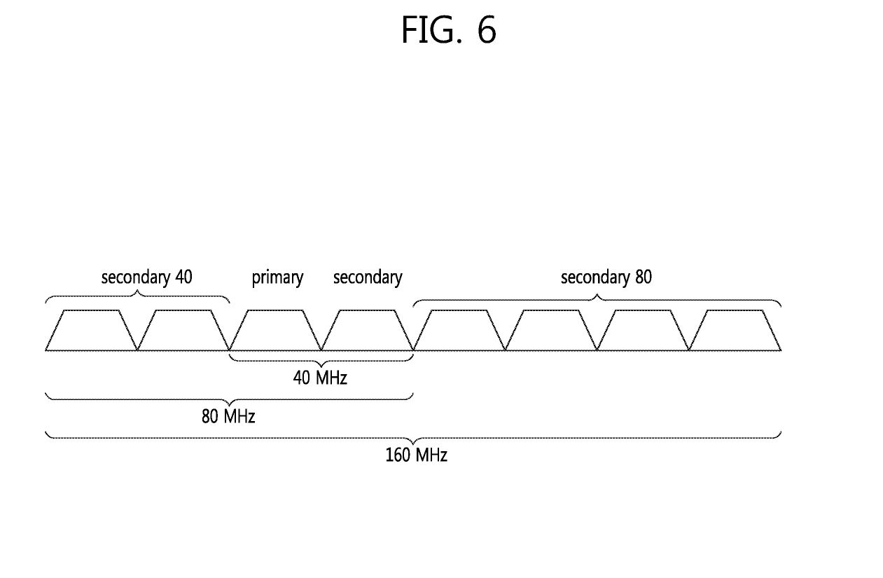

FIG. 6 illustrates the operation of channels according to IEEE 802.11ac standard.

In accordance with 802.11ac standard, a 20 MHz channel is a basic unit, and a primary channel has a 20 MHz bandwidth.

It is assumed that an STA supports a 40-MHz bandwidth. First, the STA determines whether a primary channel is idle. If the primary channel is determined to be idle and a 20-MHz secondary channel has been idle for a specific period (e.g., a Point Coordination Function (PCF) interframe space (PIFS)), the STA may send or receive data through both the primary channel and the 20-MHz secondary channel

It is assumed that an STA supports an 80-MHz bandwidth. First, the STA determines whether a primary channel is idle for the specific period. If the primary channel is determined to be idle and a 20-MHz secondary channel also was for the specific period, the STA may send or receive data through both the primary channel and the 20-MHz secondary channel If the primary channel is idle and the 20-MHz secondary channel and a 40-MHz secondary channel have was for the specific period, the STA may send or receive data through all of the primary channel, the 20-MHz secondary channel, and the 40-MHz secondary channel.

If OFDMA is introduced, however, an operation based on the primary channel may become a significant restriction to the operation of channels.

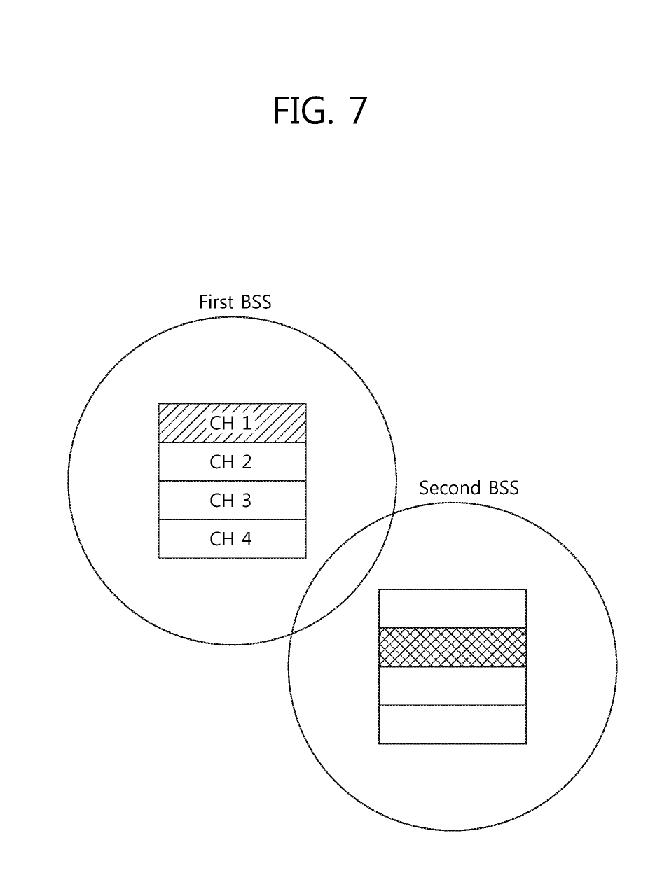

FIG. 7 illustrates limitations according to a conventional channel operation.

It is assumed that a first BSS is overlapped with a second BSS. It is also assumed that a CH1 is the primary channel of an STA and an STA belonging to the first BSS supports an 80-MHz bandwidth.

If the CH1 is idle, the STA checks whether a CH2 is idle. In this case, the CH2 is not idle due to interference in the CH2 of the second BSS. Accordingly, although the CH3 and the CH4 are idle, the STA may access only the CH1.

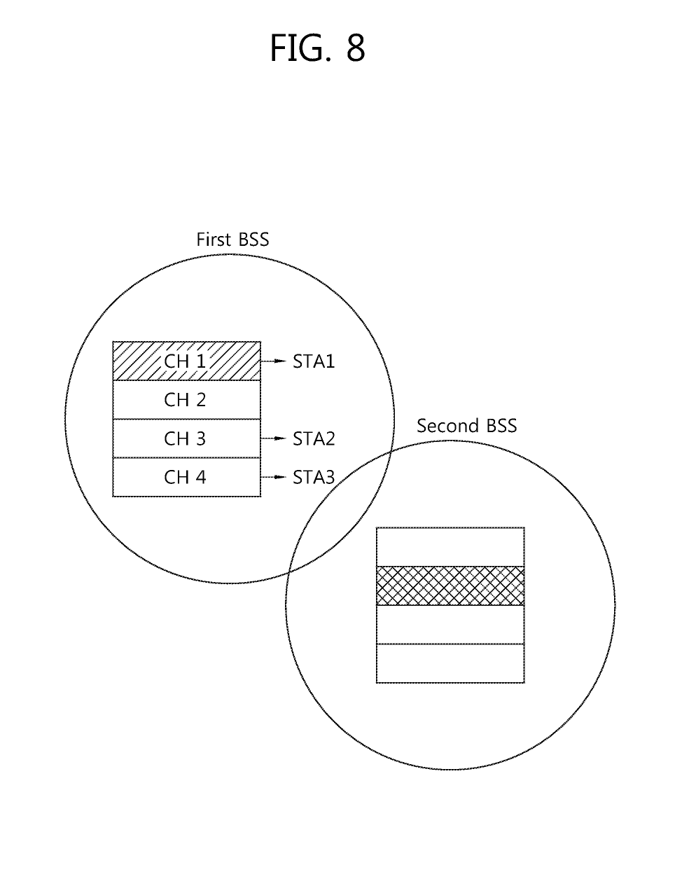

FIG. 8 illustrates an example of the operation of channels using OFDMA.

In the situation of FIG. 7, if the CH1 is allocated to an STA1 and the CH3 and the CH4 that are idle are allocated to an STA2 and an STA3, the utilization of channels can be increased.

Hereinafter, there is proposed a method for improving efficiency of a bandwidth operation and a function that needs to be considered so that multiple channels are used by a plurality of terminals not a single terminal.

1. A case where a basic unit for channel allocation is 20 MHz

There is proposed a method of operating a subband (i.e., a basic unit for resource allocation and scheduling) applied to OFDMA by maintaining the subband to 20 MHz, that is, the basic channel unit of a conventional IEEE 802.11 system.

If a subband is applied to 20 MHz equal to the size of a conventional primary channel, a system can be designed in the state in which lower compatibility can be maintained.

For an HE-PPDU, a conventional STF, LTF sequence can be used without a change. An STF, LTF sequence can be applied according to the bandwidths of an OFDMA system. If an OFDMA bandwidth is K MHz (K=20, 40, 80, 160), a K MHz STF, LTF sequence can be applied.

The L-SIG and the HE-SIG A can be duplicately applied according to a given bandwidth. If an OFDMA bandwidth is 80 MHz, an L-SIG and an HE-SIG A generated according to a 20 MHz bandwidth may be repeated three times and transmitted over the 80-MHz bandwidth.

Data may be transmitted according to an OFDMA bandwidth. Alternatively, for coverage extension and bandwidth protection, data may be generated in a 20 MHz size and may be duplicately transmitted according to an OFDMA bandwidth.

CCA may be applied in a 20 MHz unit. If a conventional primary channel rule is maintained, an STA adopts backoff, a Network Allocation Vector (NAV) configuration, and an Enhanced Distributed Channel Access (EDCA) transmission opportunity (TXOP) configuration in a primary channel.

All the channels may be independently subject to resource allocation and channel access without maintaining the conventional primary channel rule. An STA may perform backoff, may configure an NAV, and may configure an EDCA TXOP in all the channels. Whether or not to access each channel is determined depending on whether the channel is bury or idle.

An AP may send data to be transmitted to a plurality of STAs in the form of a single PPDU (this is called a DL OFDMA PPDU). An AP may perform negotiations with a plurality of STAs for a TXOP configuration. An TXOP refers to the interval in which a specific STA has a right to initiate the exchange of frames through a wireless medium. In order to protect a DL OFDMA PPDU from a legacy STA and from an STA that sends an UL PPDU, it is necessary to configure an TXOP with respect to the interval in which an OFDMA PPDU is transmitted and corresponding ACK is transmitted.

In a system to which the primary channel rule is applied, a primary channel always needs to be allocated to an AP for an NAV and TXOP configuration. If the primary channel is busy, a PPDU is unable to be transmitted. If the primary channel is idle, a secondary channel not contiguous to the primary channel may be used to send a PPDU for another STA if the secondary channel is idle. The secondary channel may be used to send a PPDU if the secondary channel is idle during the entire PIFS interval prior to the transmission of the PPDU.

In the case of a system to which the primary channel rule is not applied and that permits independent channel access for each channel, a primary channel does not need to be necessarily idle for PPDU transmission. An AP may send a PPDU through a channel that is most advantageous for an STA.

If a DL OFDMA PPDU is transmitted in the entire FFT size (e.g., four 20 MHz channels), the DL OFDMA PPDU may be modulated in an FFT size (e.g., 256 FFT) corresponding to 80 MHz.

An STA may send a PPDU (this is called an UL OFDMA PPDU) to a plurality of STAs (may include an AP). In UL, unlike in DL, it is unknown when each STA will be prepared to send UL data and when the STA will actually send the UL data. Accordingly, it is required that channels used to send an UL OFDMA PPDU be guaranteed to be an idle state according to a transmission point of time.

An AP may configure a TXOP that will be used by each STA for transmission for each channel. A TXOP holder for data transmission is for each STA, but an AP configures a TXOP.

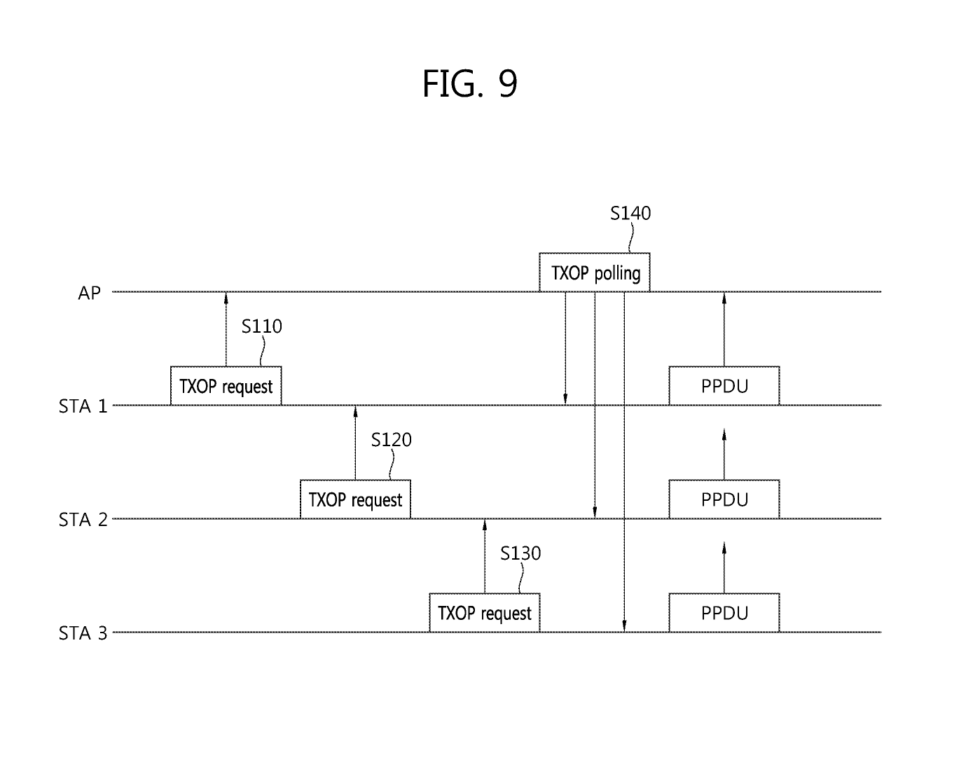

FIG. 9 illustrates an example of a TXOP configuration.

Each of STA1, an STA2, and an STA3 sends a TXOP request that requests a TXOP configuration from an AP respectively at steps S110, S120, and S130. In the present embodiment, the STA1, the STA2, and the STA3 have been illustrated as sending the TXOP requests to the AP, but the number of STAs that send the TXOP requests is not limited.

The TXOP request may include at least one of a TXOP interval, information about target STAs (e.g., the STA2 and the STA3), synchronization information for UL transmission, and channel information for UL OFDM PPDU transmission.

The TXOP requests may be sequentially transmitted from the respective STAs to the AP. For another example, a single representative STA may collect the TXOP requests and send a representative TXOP request to the AP. For yet another example, each of the STAs may send the TXOP request to the AP through a channel (or subband) allocated thereto.

The TXOP request may be transmitted by each STA during a designated interval. The TXOP request is not transmitted during the interval that is not designated. The interval may be defined by the AP.

The AP configures a TXOP and sends TXOP polling to the target STAs (S140). The TXOP polling may include the association identifiers (AID) of the STA2 and the STA3 or may include a group ID indicative of the STA2 and the STA3. TXOP polling may include at least one of a TXOP interval, synchronization information for UL transmission, and channel information for UL OFDM PPDU transmission. The TXOP polling may be used to configure the NVA of another STA.

During the TXOP, the STA1, the STA2, and the STA3 send UL PPDUs to the AP. The PPDUs of the respective STAs may be transmitted to the AP through channels that have been simultaneously allocated.

During the TXOP, the AP may send ACK for the received PPDU to the STA1, the STA2, and the STA3. The ACK may be transmitted to the STAs through channels allocated according to an OFDMA method.

The quality of a link between the AP and each STA may be different for each channel. Accordingly, it may be required to guarantee a GI of a sufficient length for UL-OFDMA transmission. A prior art includes two GIs: a short GI and a long GI, but a GI longer than the long GI (this is called a double GI) may be required. Upon UL transmission, an HE-SIG A may include information about whether the double GI is applied.

If an UL OFDMA PPDU is transmitted over the entire FFT size (e.g., four 20 MHz channels), the UL OFDMA PPDU may be modulated in an FFT size (e.g., 256 FFT) corresponding to 80 MHz.

2. A case where a basic unit for channel allocation is 20 MHz or less

There is proposed a method of operating channels when a subband (a basic unit for resource allocation and scheduling) applied to OFDMA is smaller than 20 MHz, that is, the basic channel unit of a conventional IEEE 802.11 system. For example, the subband may be any one of 1 MHz, 2 MHz, 2.5 MHz, 5 MHz, and 10 MHz.

If the subband is smaller than the size of a conventional primary channel, it is difficult to maintain a conventional functionality, but system performance can be optimized.

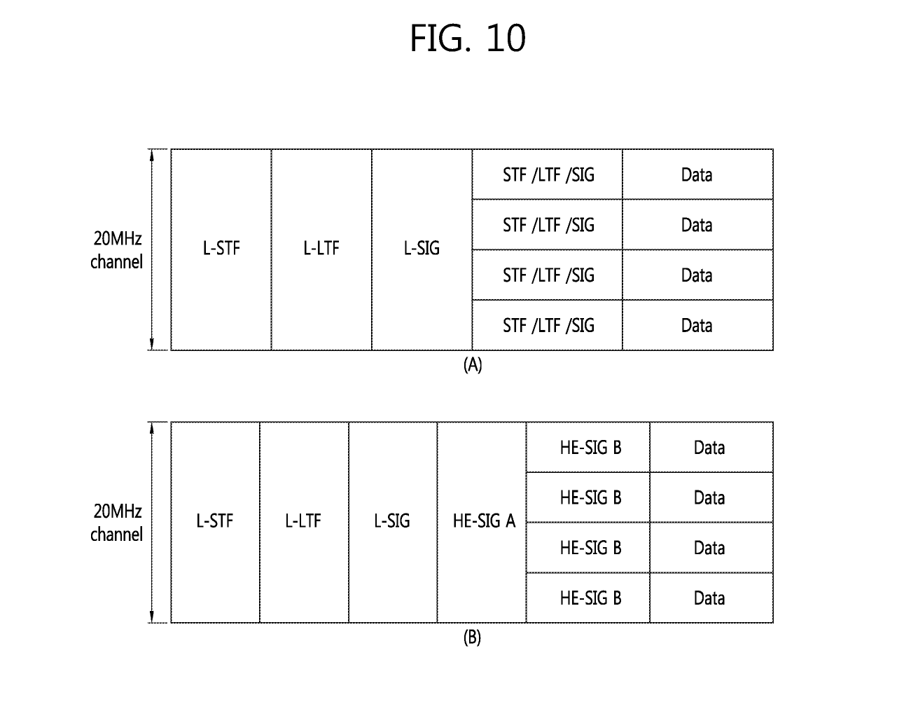

FIG. 10 illustrates an example of a proposed PPDU format.

It is assumed that a subband has a 5 MHz bandwidth and is transmitted in a 20 MHz channel.

In the PPDU of subfigure (A) of FIG. 10, a legacy part (i.e., an L-STF, an L-LTF, and an L-SIG) reuses a conventional PPDU format with a granularity of a 20 MHz unit. An STF/LTF/SIG for an HE system may be designed and applied as a subband. A legacy STA may configure an NAV by receiving the legacy part. The SIG may include any one of the aforementioned fields within the HE-SIG A and HE-SIG B.

In the PPDU of subfigure (B) of FIG. 10, an HE-SIG A having common control information has a granularity of a 20 MHz unit. The operation of a 20 MHz unit for an HE STA is possible.

Data for each STA may be configured according to a subband granularity. Alternatively, for coverage extension and bandwidth protection, data may be duplicated and transmitted.

If CCA rules are set up for each subband, complexity may be increased due to too many types of CCA bandwidths. A subband is set to be smaller than 20 MHz, but CCA may maintain a 20 MHz unit. A primary channel rule of a 20 MHz unit may be applied, or CCA may be independently applied for each 20 MHz channel. If a PPDU includes a legacy part as illustrated in FIGS. 10(A) and 10(B), CCA may be performed based on the legacy part or may be performed through an HE-SIG.

A TXOP configuration when an extended FFT size is applied to a PPDU is described below.

If the number of available subcarriers has been increased by applying a greater FFT size in a given bandwidth, an HE system requires a method in which the HE system and a legacy STA coexist. In particular, coverage extension needs to be guaranteed as far as possible because to operate a WLAN in an outdoor environment belongs to one of the scopes of an HE system.

For a TXOP configuration, a Request-To-Send (RTS)/Clear-To-Send (CST) procedure may be used.

When a TXOP for an HE system is configured, the RTS/CTS procedure may be used. For a legacy STA, an FFT size is not increased with respect to RTS/CTS frames, but an FFT size may be increased with respect to frames that are exchanged during a TXOP. In accordance with such a method, however, a coverage extension effect may not be sufficient because TXOP protection is performed on only an STA present within a range in which RTS/CTS have been set.

The RTS frame may be transmitted in an HE-PPDU form. The CTS frame may also be transmitted in an HE-PPDU form. A legacy STA that has received the legacy part of an RTS frame may configure an NAV through an L-SIG.

A legacy STA that has not configured an NAV because the legacy STA is present in the extended coverage of an HE system and thus has not detected the legacy part of an RTS frame may operate as follows.

The legacy STA continues to perform scanning because it may detect the HE parts (i.e., the HE-SIG A, the HE-STF, the HE-LTF, and an HE-SIG B) of an HE PPDU. Alternatively, the legacy STA may perform power control of the legacy part of an RTS frame (or CTS frame) by taking coverage into consideration.

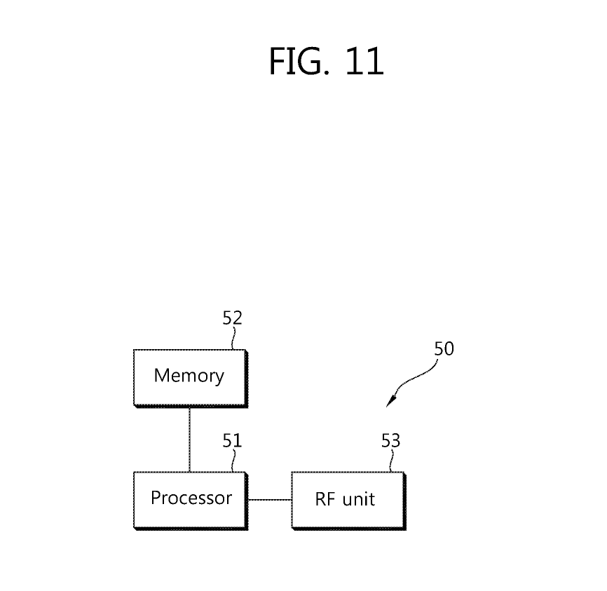

FIG. 11 is a block diagram illustrating a wireless device in which an embodiment of the present invention is implemented.

A device 50 includes a processor 51, memory 52, and a Radio Frequency (RF) unit 53. The wireless device may be an AP or a non-AP STA in the aforementioned embodiments. The RF unit 53 is connected to the processor 51 and sends and/or receives radio signals. The processor 51 implements the proposed functions, processes and/or methods. The operation of an AP or a non-AP STA in the aforementioned embodiments may be implemented by the processor 51. The memory 52 is connected to the processor 51 and may store instructions for implementing the operation of the processor 51.

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. A method for transmitting data in a wireless local area network, the method comprising:
receiving, by an access point (AP), a plurality of transmission opportunity (TXOP) requests for requesting a TXOP configuration from a plurality of transmission stations;
transmitting, by the AP, a TXOP polling regarding the TXOP configuration to the plurality of transmission stations; and
receiving, by the AP, a plurality of data blocks from the plurality of transmission stations during the configured TXOP.

2. The method of claim 1, wherein the plurality of data blocks include a plurality of physical layer protocol data units (PPDUs).

3. The method of claim 1, wherein each of the plurality of TXOP requests includes information about a corresponding transmission station.

4. The method of claim 1, wherein each of the plurality of TXOP requests includes information about a channel through which a corresponding data block is transmitted.

5. The method of claim 1, wherein the TXOP polling includes a group identifier identifying the plurality of transmission stations.

6. The method of claim 1, further comprising:
transmitting, by the AP, an ACK regarding the plurality of data blocks to the plurality of transmission stations during the configured TXOP.

7. A device for a wireless local area network, the device comprising:
a radio frequency (RF) unit configured to transmit and receive radio signals; and
a processor connected to the RF unit and configured to:
instruct the RF unit to receive a plurality of transmission opportunity (TXOP) requests for requesting a TXOP configuration from a plurality of transmission stations;
instruct the RF unit to transmit a TXOP polling regarding the TXOP configuration to the plurality of transmission stations; and
instruct the RF unit to receive a plurality of data blocks from the plurality of transmission stations during the configured TXOP.

8. The device of claim 7, wherein the plurality of data blocks include a plurality of physical layer protocol data units (PPDUs).

9. The device of claim 7, wherein each of the plurality of TXOP requests includes information about a corresponding transmission station.

10. The device of claim 7, wherein each of the plurality of TXOP requests includes information about a channel through which a corresponding data block is transmitted.
